(19) United States
(12) Patent Application Publication
(10) Pub. No.: US 2015/0219900 A1
(43) Pub. Date: Aug. 6, 2015

(54) Adjustable Display Mounting

(71) Applicants: Bradley Rhodes, Alameda, CA (US); Daniel Kelly, Seattle, WA (US); Clifford L. Biffle, Berkeley, CA (US)

(72) Inventors: Bradley Rhodes, Alameda, CA (US); Daniel Kelly, Seattle, WA (US); Clifford L. Biffle, Berkeley, CA (US)

(73) Assignee: GOOGLE INC., Mountain View, CA (US)

(21) Appl. No.: 13/428,478

(22) Filed: Mar. 23, 2012

Related U.S. Application Data
(60) Provisional application No. 61/509,826, filed on Jul. 20, 2011.

(51) Int. Cl. G09G 5/00

(52) U.S. Cl. CPC G02B 27/0176; G02B 27/0101; G02B 27/0179; G02B 2027/0123; G02B 2027/0178; G02B 2027/0187

(57) ABSTRACT

A head-mounted display includes a head-mounted support and a display device. The display device has an aperture through which a computer-generated image is viewable along a viewing axis. A support mount is on the head-mounted support. A display mount is on the display device. The display mount is adjustable relative to the support mount so as to adjust the position and/or orientation of the viewing axis.

### CROSS-REFERENCE TO RELATED APPLICATIONS

This application claims priority to U.S. Provisional Patent Application Ser. No. 61/509,826 filed Jul. 20, 2011, the contents of which are hereby incorporated by reference.

### BACKGROUND

Wearable systems can integrate various elements, such as miniaturized computers, input devices, sensors, detectors, image displays, wireless communication devices as well as image and audio processors, into a device that can be worn by a user. Such devices provide a mobile and lightweight solution to communicating, computing and interacting with one's environment. With the advance of technologies associated with wearable systems and miniaturized optical elements, it has become possible to consider wearable compact optical displays that augment the wearer's experience of the real world.

By placing an image display element close to the wearer's eye(s), an artificial image can be made to overlay the wearer's view of the real world. Such image display elements are incorporated into systems also referred to as “near-eye displays”, “head-mounted displays” (HMDs) or “heads-up displays” (HUDs). Depending upon the size of the display element and the distance to the wearer's eye, the artificial image may fill or nearly fill the wearer's field of view.

### SUMMARY

In a first aspect, a head-mounted display is provided. The head-mounted display includes a head-mounted support and a display device. The display device has an aperture through which an image is viewable along a viewing axis from a viewing point. A support mount is on the head-mounted support. The support mount includes an adjustment surface. A display mount is on the display device. The display device is magnetically attached to the support mount such that the display mount is slidably adjustable on the adjustment surface through an adjustment range that moves the aperture of the display device along an arc. The arc is centered on the viewing point and the viewing axis extends between the aperture and the viewing point throughout the adjustment range.

In a second aspect, a head-mounted display is provided. The head-mounted display includes a head-mounted support and a display device. The display device has an aperture through which an image is viewable along a viewing axis from a viewing point. A support mount is on the head-mounted support. The support mount includes an adjustment surface. A display mount is on the display device. The display mount is magnetically attachable to the adjustment surface in a plurality of discrete mounting positions. Each of the discrete mounting positions corresponds to a respective position of the aperture of the display device along an arc. The arc is centered on the viewing point and the viewing axis extends between the aperture and the viewing point for each of the discrete mounting positions.

In a third aspect, a head-mounted display is provided. The head-mounted display includes a head-mounted support and a display device. The display device has an aperture through which an image is viewable along a viewing axis. A support mount is on the head-mounted support. A display mount is on the display device. The display device includes a convex mounting surface that has a plurality of facets. The display mount is magnetically attachable to the support mount in a plurality of discrete mounting orientations defined by the plurality of facets. Each of the discrete mounting orientations corresponds to a respective orientation of the viewing axis.

### BRIEF DESCRIPTION OF THE DRAWINGS

FIG. 1 is a top view of a head-mounted display in accordance with an example embodiment.

FIG. 2 is a side view of the head-mounted display of FIG. 1 in accordance with an example embodiment.

FIG. 3A is a front view and FIG. 3B is a side cutaway of a faceted support mount and a corresponding display mount in accordance with an example embodiment.

FIG. 4 is a side cutaway view of a curved support mount and a corresponding display mount in accordance with an example embodiment.

FIG. 5 is a side cutaway view of a sawtooth-textured support mount and a corresponding display mount in accordance with an example embodiment.

FIG. 6 is a front view of a head-mounted display with support and display mounts on opposite sides of the display device in accordance with an example embodiment.

FIG. 7 is a side view of a head-mounted display with display device mounted to a hat-type head-mounted support in accordance with an example embodiment.

FIG. 8A is a side partial cutaway view and FIG. 8B is a top view of a display device with a faceted device mount in accordance with an example embodiment.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description and figures are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. Overview

A head-mounted display (“HMD”) may enable its wearer to observe the wearer's real-world surroundings and also view a displayed image, such as a computer-generated image. In some cases, the displayed image may overlay a portion of the wearer's field of view of the real world. Thus, while the wearer of the HMD is going about his or her daily activities, such as walking, driving, exercising, etc., the wearer may be able to see a displayed image generated by the HMD at the same time that the wearer is looking out at his or her real-world surroundings.

The displayed image might include, for example, graphics, text, and/or video. The content of the displayed image could relate to any number of contexts, including but not limited to the wearer's current environment, an activity in which the wearer is currently engaged, the biometric status of the wearer, and any audio, video, or textual communications that have been directed to the wearer. The images displayed by the HMD may also be part of an interactive user interface. For example, the HMD could be part of a wearable computing device. Thus, the images displayed by the HMD could include menus, selection boxes, navigation icons, or other user interface features that enable the wearer to invoke functions of the wearable computing device or otherwise interact with the wearable computing device.

The images displayed by the HMD could appear anywhere in the wearer's field of view. For example, the displayed image might occur at or near the center of the wearer's field of view, or the displayed image might be confined to the top, bottom, or a corner of the wearer's field of view. Alternatively, the displayed image might be at the periphery of or entirely outside of the wearer's normal field of view. For example, the displayed image might be positioned such that it is not visible when the wearer looks straight ahead but is visible when the wearer looks in a specific direction, such as up, down, or to one side. In addition, the displayed image might overlay only a small portion of the wearer's field of view, or the displayed image might fill most or all of the wearer's field of view. The displayed image could be displayed continuously or only at certain times (e.g., only when the wearer is engaged in certain activities).

Different wearers may have different preferences when viewing images displayed by the HMD. For example, some wearers may prefer to have the images displayed near the top of the wearer's field of view (or to be outside of the wearer's field of view except when the wearer looks up), while other wearers may prefer to have the images near the center or near the bottom of the wearer's field of view. In addition, a wearer's preferences may be dependent on what is being displayed, the wearer's current environment, the wearer's current activity, and/or other factors. Thus, a particular HMD wearer may prefer to have the displayed images appear at or near the center of the wearer's field of view in some situations but may prefer to have the displayed images appear in a more peripheral location (or only be visible when looking in a specific direction) in other situations. In other cases, the wearer may make such adjustments in order to customize the HMD to the specific size and shape of the wearer's physical features and/or manner of wearing the HMD.

Given these wearer-dependent preferences, it can be beneficial to allow the wearer to adjust how the displayed images appear in the wearer's field of view. To achieve this, an HMD may include an adjustable display mounting. For example, a display device (the part of the HMD that displays the images) can be provided with a display mount that is adjustable relative to a support mount on a head-mounted support (the part of the HMD that is mounted on the wearer). The display device could be, for example, a see-through display or a projector. The head-mounted support could be configured, for example, as eyeglass, goggles, a helmet, a head-band, or a hat. Instead of a head-mounted support, the support mount could be on a wearer-mounted support that is mounted on the wearer in other ways, such as on one or both of the wearer's shoulders or on a backpack being worn by the wearer.

An HMD could be configured to allow adjustment of one or more components of the orientation of the display device (e.g., pitch, yaw, and roll) and/or one or more components of the position of the display device (e.g., its vertical position, horizontal position, or distance from the wearer). The adjustment provided by the HMD could be a continuous adjustment, a discrete adjustment, or a combination of these. In one example, the HMD could be configured to allow the position of the display device to be continuously adjustable in a horizontal plane and the orientation of the display device about one of its axes (e.g., the “yaw” of the display device) to be continuously adjustable, while the orientation of the display device about its other two axes (e.g., the “pitch” and “roll” of the display device) might be adjustable in discrete increments. In another example, the HMD could be configured to allow the pitch of the display device to be continuously adjustable but without providing for adjustment of the roll or yaw of the display device. In addition to these examples, a HMD could be configured for other types of adjustment.

In some cases, the images displayed by the display device in the HMD are viewable through an aperture of the display device along a particular viewing axis. Thus, it may be beneficial to configure the HMD such that adjustment of the position of the display device also adjusts the orientation of the display device such that the viewing axis is directed to the wearer's eye. For example, an HMD could be configured to allow the position of the display device to be adjustable in a vertical plane such that the aperture of the display device remains oriented toward the wearer's eye (i.e., so that the viewing axis extends between the wearer's eye and the aperture of the display device). This can be achieved by allowing the display device to move in the vertical plane along an arc that is centered on the wearer's eye. With this configuration, the wearer can adjust the vertical position of where the displayed images appear in the wearer's field of view.

The adjustment of the orientation and/or position of a display device in the HMD may involve interaction between a display mount on the display device and a corresponding support mount on the head-mounted support. For example, the display mount may be magnetically attachable to the support mount. The magnetic attachment may be sufficiently strong to allow the display device to remain in place (e.g., in a desired position and/or orientation) while the HMD is being worn. In some configurations, the position and/or orientation of the display mount relative to the support mount can be adjusted by the wearer of the HMD while the display mount and the support mount are magnetically attached together. For example, the wearer may be able to slide the display mount over the support mount or rotate the display mount on the support mount in order to select a particular mounting position or orientation. In other configurations, the wearer might adjust the mounting position or orientation by detaching the display mount from the support mount and then re-attaching it in a different position or orientation. In some cases, the wearer might adjust the support mount while leaving the display mount in the same position relative to the support mount. Alternatively, the wearer might adjust both the support mount and the display mount, either one at a time or simultaneously.

The configuration of the display mount and the support mount may determine what type of adjustment is available in the HMD and whether the adjustment is continuous or discrete. For example, the display mount can be fixedly attached to the display device such that movement of the display mount on the support mount results in a corresponding movement of the display device and of the aperture of the display device through which the displayed images are visible.

In one example, the support mount includes a flat adjustment surface. The position of the display mount on the flat adjustment surface may then be continuously adjustable (e.g., by sliding the display mount on the adjustment surface) so as to allow the position of the aperture of the display device to be adjusted in a plane that is parallel to the flat adjustment surface.

However, the flat adjustment surface could be located in a slot or channel having a width that is the same or similar to the width of the display mount. In that case, the support mount might substantially restrict adjustment of the display mount to one dimension (defined by the slot). For example, a support mount with a vertically oriented slot may allow the position of the display mount (and, thus, the display device) to be adjusted vertically but allow for little or no adjustment horizontally. The slot may help hold the display in place (e.g., keep it from sliding due to walking) and to dampen vibrations from walking.

Instead of a flat adjustment surface, the support mount could include a curved adjustment surface. The curved adjustment surface could be either convex or concave. For example, the support mount might include a convex, arcuate adjustment surface in a vertically oriented slot. The display mount may be able to slide up and down on the arcuate adjustment surface so as to adjust the position of the display device (more particularly, the position of the aperture of the display device) along an adjustment arc in a vertical plane. The adjustment arc could be centered on an eye of the wearer of the HMD or on some other point, depending on the shape of the adjustment surface and where on the head-mounted support it is placed.

A support mount with a smooth adjustment surface may allow for continuous adjustment of the position of the display mount. However, a support mount with an adjustment surface that is textured, e.g., with facets, detents, grooves, notches, or a sawtooth pattern, may allow for discrete adjustment of the position of the display mount. In particular, the facets, sawtooth pattern, or other texturing on the adjustment surface may define a set of discrete mounting positions where the display mount can be attached to the support mount.

In addition to (or instead of) the position of the display mount on the support mount being adjustable, the orientation of the display mount relative to the support mount may be adjustable. For example, the display mount could have a convex or concave mounting surface that allows the angle of the display mount relative to the support mount to be adjusted. This, in turn, may allow the orientation of the display device (e.g., its pitch, yaw, or roll) to be adjusted. Even with a flat mounting surface, the display mount could be rotatable with respect to the support mount so as to allow some adjustment of the orientation of the display device.

As with its mounting position, the mounting orientation of the display mount relative to the support mount could be either continuously or discretely adjustable. For example, the display mount could include a smooth mounting surface that allows for continuous adjustment of at least one component of the display mount's orientation. Alternatively, the display mount could include a textured mounting surface that includes, for example, a plurality of facets or a sawtooth pattern. The facets, sawtooth pattern, or other texturing may define a set of discrete mounting orientations of the display mount on the support mount.

By allowing the position and/or orientation of the display device to be adjusted by appropriate adjustment of a display mount on the display device relative to a support mount on the head-mounted support, an HMD wearer may be able to adjust where displayed images appear in the wearer's field of view or to move the displayed images out of the wearer's field of view entirely. In some cases, a wearer may make such adjustments based on the wearer's preferences. In other cases, the wearer may make such adjustments in order to customize the HMD to the specific size and shape of the wearer's physical features and/or manner of wearing the HMD.

Certain illustrative examples of adjustable display mountings are described below. It is to be understood, however, that other types of adjustable display mountings could be used to provide continuous adjustment, discrete adjustment, or a combination of continuous and discrete adjustment of one or more components of the position and/or orientation of a display element in an HMD.

2. Display Mounting with Arcuate Adjustment in a Vertical Plane

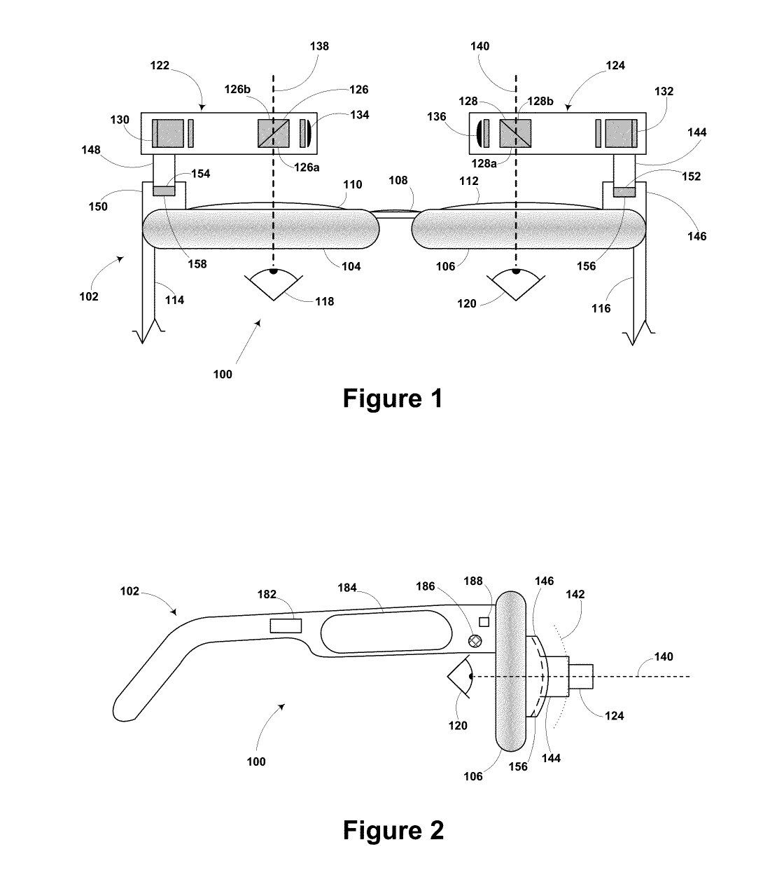

FIGS. 1 and 2 illustrate an example HMD 100 with adjustable display mountings that allow for arcuate adjustment in a vertical plane. In this example, HMD includes a head-mounted support 102 that is configured in the form of eyeglasses. It is to be understood, however, that other configurations are possible.

As shown in FIGS. 1 and 2, head-mounted support 102 includes lens-frames 104 and 106, a center frame support 108, lens elements 110 and 112, and extending side-arms 114 and 116. The center frame support 108 and the extending side-arms 114 and 116 are configured to secure the head-mounted support 102 to a wearer's head via the wearer's nose and ears, respectively. Each of the frame elements 104, 106, and 108 and the extending side-arms 114 and 116 may be formed of a solid structure of plastic or metal, or may be formed of a hollow structure of similar material so as to allow wiring and component interconnects to be internally routed through the head-mounted support 102. Alternatively or additionally, head-mounted support 102 may support external wiring.

Lenses 110 and 112 are at least partially transparent so as to allow the wearer to look through them. In particular, the wearer's left eye 118 may look through left lens 110 and the wearer's right eye 120 may look through right lens 112. Display devices 122 and 124 may be positioned in front of lenses 110 and 112, respectively, as shown in FIGS. 1 and 2. Although this example includes a display device for each of the wearer's eyes, it is to be understood, that a HMD might include a display device for only one of the wearer's eyes (either left eye 118 or right eye 120).

In this example, display devices 122 and 124 are see-through displays that the wearer is able to look through to observe the real world and also observe a displayed image. As illustrated schematically in FIG. 1, display devices 122 and 124 include beam splitters 126 and 128, respectively, through which the user is able to look and see the real world. In an example embodiment, beam splitters 126 and 128 each have a generally cubical shape and, thus, provide a generally square aperture through which the wearer is able to look. The faces of beam splitters 126 and 128 that are closest to the wearer's eyes 118 and 120 are identified in FIG. 1 as apertures 126a and 128a, respectively. The faces opposite apertures 126a and 128a, through which light from the outside world enters beam splitters 126 and 128, are identified in FIG. 1 as viewing windows 126b and 128b, respectively.

In one example, apertures 126a and 128a each have dimensions of about 10 millimeters by 10 millimeters. However, the dimensions of the aperture could be either larger or smaller. In addition, instead of a generally square shape, the aperture could have a rectangular or other shape.

Display devices 122 and 124 also include components to generate images. In an example embodiment, each display device generates an image by means of a respective display panel that generates a light pattern (e.g., a pattern of light emitted from an emissive display panel or spatially-modulated light reflected from a reflective display panel) and a respective image former, such as a concave mirror, that forms a virtual image based on the light pattern. Thus, display devices 122 and 124 are shown in FIG. 1 with respective display panels 130 and 132 and respective concave mirrors 134 and 136.

The beam splitter in the display device reflects the light from the image former so that the virtual image is viewable along a viewing axis. In FIG. 1, display device 122 is shown with a viewing axis 138 and display device 124 is shown with a viewing axis 140. More particularly, viewing axes 138 and 140 for display devices 122 and 124 extend through their respective beam splitters 126 and 128 and correspond to the direction that the wearer would look in order to observe the real world through the respective apertures 126a and 128a. Thus, both the real world and the virtual image generated by a display device are viewable along the display device's viewing axis. As shown in FIG. 2, the HMD may also include a computer 182, touch pad 184, microphone 186 and sensor 188. The computer 182 may control the content of the virtual images displayed by display device 122 and 124. Furthermore, touch pad 184 and microphone 186 and sensor 188 may be used by the computer to obtain user and environmental information to display contextually relevant virtual images.

In one configuration, the viewing axis corresponds to a direction straight in front of the viewer. This is shown in FIG. 2, with viewing axis 140 for right eye 120 in a horizontal orientation (e.g., parallel or nearly parallel to the floor or the ground). However, the orientation of viewing axis 140 may be adjusted through an adjustment range. In the example illustrated in FIG. 2, the adjustment range corresponds to a range of angles subtended by an adjustment arc 142 that lies in a vertical plane and is centered on right eye 120 of the wearer. Viewing axis 138 for left eye 118 may be similarly adjustable in a vertical plane through a range of adjustment angles subtended by an adjustment arc that is centered on left eye 118. Adjustment arc 142 has a radius of curvature corresponding to the distance between aperture 128a and right eye 120. The adjustment arc for left eye 118, which corresponds to the distance between aperture 126a and left eye 118, could have a radius of curvature that is the same as or different than that of adjustment arc 142. Apertures 126a and 128a may be described as apertures as they define the field of view of the viewable image.

The adjustment arc 142 for right eye 120 is defined by a display mount 144 on display device 124 and a support mount 146 on lens-frame 106 of head-mounted support 102. The adjustment arc (not shown) for left eye 118 may be similarly defined by a display mount 148 on display device 122 and a support mount 150 on lens-frame 104 of head-mounted support 102. More particularly, support mount 146 may include an adjustment surface 152 that has a curved shape (support mount 150 may include a similar adjustment surface 154). The curved shape of adjustment surface 152 corresponds to an arc centered at right eye 120, i.e., like adjustment arc 142 but with a smaller radius of curvature. In addition, the arc defined by the curved shape of adjustment surface 152 is in a vertical plane that is horizontally displaced from and parallel to the vertical plane containing adjustment arc 142.

Display mount 144 is able to slide over adjustment surface 152 to sweep through a range of angles. With display mount 144 fixedly attached to display device 124, this causes display device 124, including aperture 128a, to sweep through the same range of angles. Further, since adjustment arc 142 is centered on right eye 120, viewing axis 140 extends between aperture 128a and right eye 120 throughout the range of adjustment angles. As a result, the real world and virtual image generated by display device 124 can remain viewable through aperture 128a from right eye 120 as the orientation of viewing axis 140 is adjusted. Of course, right eye 120 may need to look up or down when the orientation of viewing axis 140 is adjusted up or down. Viewing axis 138 may be similarly adjusted by sliding display mount 148 on adjustment surface 154. Sliding display mounts 144 and 148 on adjustment surfaces 152 and 154 maintains a constant distance between each display device and the wearer's corresponding eye, for example, to present a uniform brightness and eyebox to the wearer.

In an example embodiment, support mounts 146 and 150 are configured to allow display mounts 144 and 148 to slide vertically over adjustment surfaces 152 and 154, respectively, while substantially restricting horizontal movement of the display mounts. As shown in FIG. 1, this can be achieved by the use of slots 156 and 158 in support mounts 146 and 150, respectively, which have horizontal dimensions (widths) that substantially correspond to the widths of display mounts 144 and 148. Thus, display mounts 144 and 148 fit into slots 156 and 158 such that display mounts 144 and 148 are able to move vertically, but horizontal movement of the display mounts is substantially restricted by the widths of the slots in which they fit.

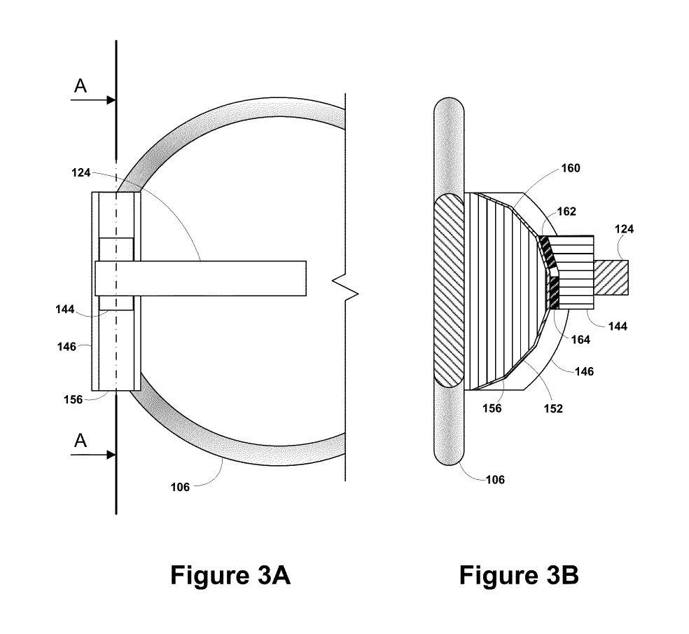

Adjustment surfaces 152 and 154 may correspond to the surfaces of metal strips that are placed in slots 156 and 158, respectively. For example, FIG. 3A is a front view view of support mount 146 and display mount 144, and FIG. 3B is a cutaway view that shows a metal strip 160 in slot 156. FIG. 3B is a cutaway looking from left to right at section line ‘A’ in FIG. 3A. The metal strip 160 could be, for example, a strip of spring steel or other ferrous material to which display mount 144 can be magnetically attached. Adjustment surface 154 in support mount 150 could be provided as a similar metal strip.

To provide for magnetic attachment, display mount 144 may include one or more magnets, which are exemplified in FIG. 3B by magnets 162 and 164. Although FIG. 3B shows two magnets in display mount 144, it is to be understood display mount 144 could include a greater or fewer number of magnets. The magnets in display mount 144 could be any type of magnet that can magnetically attach to support mount 146 so as to support display device 144 while HMD is being worn. For example, magnets 162 and 164 in display mount 144 could be a neodymium magnet or other type of rare earth magnet. Display mount 148 may include similar magnets.

Although FIG. 3B illustrates an example in which display mount 144 includes magnets and support mount 146 includes a ferrous material to which the magnets in display mount 144 can be magnetically attached, it is to be understood that support mount 146 may also include magnets. Thus, display mount 144 may include one or more magnets that are magnetically attachable to a corresponding set of one or more magnets in support mount 146. Alternatively, instead of magnets, display mount 144 may include a ferrous material that is magnetically attachable to one or more magnets in support mount 146. A plurality of flat facets along adjustment surface 152 may allow the user to adjust the HMD in discrete angle steps.

Further, although FIG. 3B shows display mount 144 with flat mounting surfaces corresponding to the flat faces of magnets 162 and 164, it is to be understood that display mount 144 could instead have a curved mounting surface. For example, display mount 144 could be provided with a curved mounting surface by including a curved sheet of ferrous material.

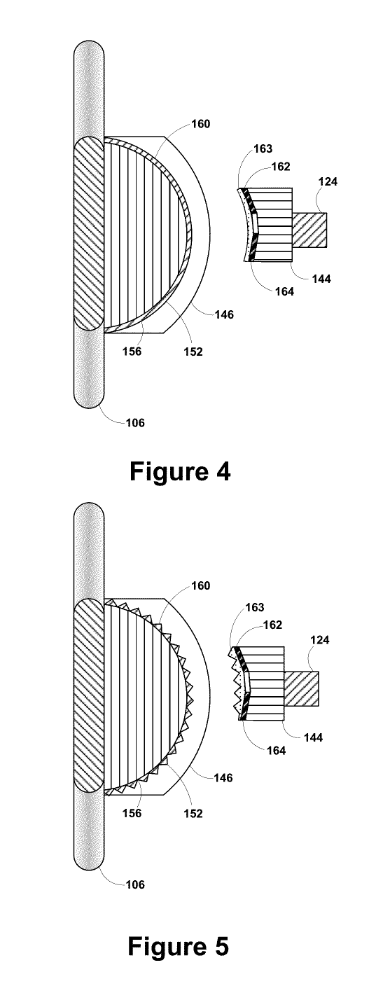

The curved sheet of ferrous material corresponds to display mount surface 163 over magnets 162 and 164 as shown in FIG. 4, which is a cutaway looking from left to right at section line ‘A’ in FIG. 3A. The curved mounting surface of display mount 144 and faces of magnets 162 and 164 could match the curved surface in slot 156 in support mount 146. A continuous curve along adjustment surface 152 may allow the user to adjust the HMD in a continuous manner, without discrete steps. For clarity in this illustration, display mount 144 has been depicted separate from the support mount 146.

FIG. 5, which is a cutaway looking from left to right at section line ‘A’ in FIG. 3A, illustrates an example in which support mount 146 includes a sawtooth adjustment surface 152. Correspondingly, sawtooth-patterned display mount surface 163 is configured to align into the sawtooth pattern at various discrete angle positions along the vertical slot 156. The display mount surface 163 and adjustment surface 152 may be formed from magnetic and/or ferrous materials. Magnetic forces may hold the display mount in place with respect to the adjustment surface. The user may demount and remount the display device in order to adjust the viewing position in the vertical dimension. For clarity in this illustration, display mount 144 has been depicted separate from the support mount 146. The sawtooth pattern (and other textured surfaces) may provide more stability to the mount, as compared to a smooth surface, such that vertical slot 156 could be widened or omitted altogether.

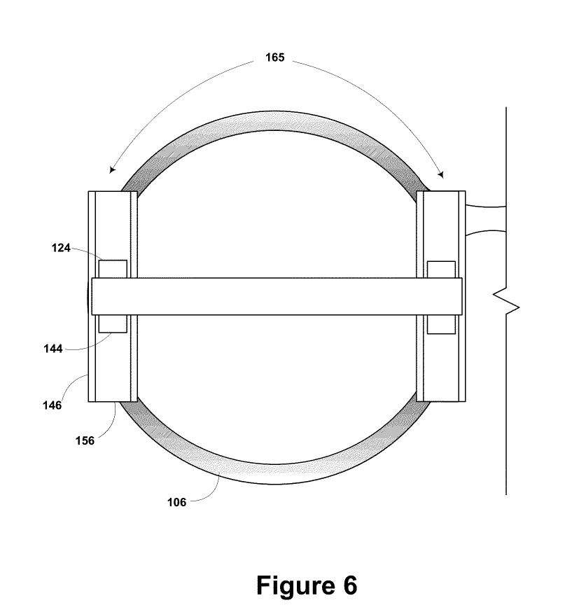

FIG. 6 illustrates how a HMD may be configured to have curved metal surfaces 165 for display device 124 on opposite sides of a lens frame 106. Display device 124 is thus slidably adjustable in an arc in the vertical direction. This example may allow a more stable mount for the display device 124 compared to other example embodiments. Further, because of this greater stability, this example embodiment may allow horizontal adjustment of display device 124 by widening vertical slot 156. Additionally, this example embodiment may omit vertical slot 156 entirely, which may allow further horizontal adjustment. Although FIG. 6 shows a single display system on one side of a glasses-type HMD, it is to be understood that a plurality of display systems could be adjustably mounted in this manner, for instance over both eyes in a glasses format. It is to be further understood that a plurality of curved metal surfaces 165 greater than two may be used to attach display system 124 to lens frame 106.

3. Display Device Mount with Multiple Degrees of Freedom

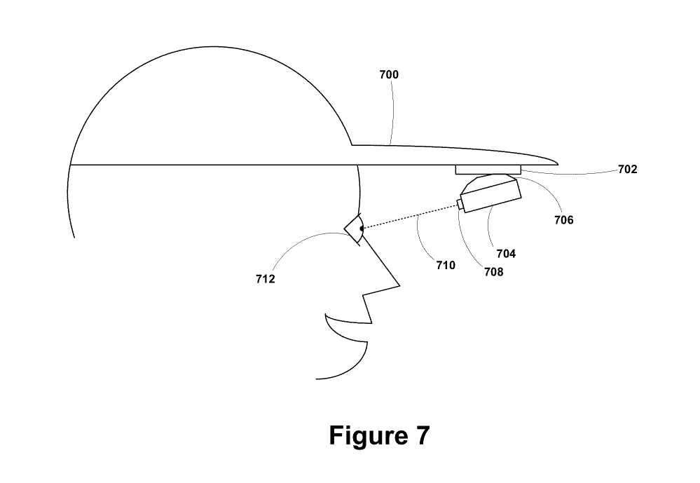

FIG. 7 shows a HMD that includes a head-mounted support 700, with a support mount 702, and a display device 704, with a display device mount 706, which allows for adjustment in multiple degrees of freedom. In this example, head-mounted support 700 is in the form of a hat and support mount 702 is mounted on the underside of the brim of the hat. The display device 704 includes an aperture 708 through which images (e.g., computer-generated images) are viewable along a viewing axis 710. The wearer of head-mounted support 700 may adjust the position and/or orientation of display device mount 706 on support mount 702 so that viewing axis 710 extends from aperture 708 to the wearer's eye 712, as shown in FIG. 7. In this configuration, the wearer may view the images displayed by display device 704. However, when the wearer no longer desires to view the images displayed by display device 704, the wearer may change the position and/or orientation of display device mount 706 on support mount 702 so that viewing axis 710 no longer extends to the wearer's eye 712. The wearer may also change the position and/or orientation of display device mount 706 on support mount 702 in order to reposition the display within the wearer's overall field of view.

Display device mount 706 is magnetically attachable to support mount 702 so that display device 704 stays fixed relative to support mount 702 while the wearer is wearing head-mounted support 700. For example, display device mount 706 may include one or more magnets and support mount 702 may include ferrous materials, or vice versa. Alternatively, display device mount 706 and support 702 may each include one or more magnets.

Support mount 702 and display device mount 706 could be configured such that, when they are magnetically attached together, the position and/or orientation of display device mount 706 is slidably adjustable on support mount 702. Alternatively, display device mount 706 could be detached from support mount 702 and then re-attached in a different position and/or orientation.

In an exemplary embodiment, support mount 702 includes a flat surface and display device mount 706 includes a convex surface that allows one or more components of the orientation of display device 704 (such as pitch, yaw, and roll) to be adjusted. The adjustments could be either continuous, discrete, or involve a combination of discrete and continuous adjustments. For example, display device mount 706 may include a two-dimensional array of facets (i.e., a “tortoise shell” configuration) that allows the pitch and roll of display device 704 to be adjusted in discrete increments. However, the yaw of display device 704 may be continuously adjustable, for example, by rotating display device mount 706 about a vertical axis on support 702. The position of display device 704 may also be continuously adjustable (e.g., in a plane parallel to support mount 702) by sliding display device mount 706 on support mount 702.

Although FIG. 7 shows support mount 702 as having a smooth and flat surface, it is to be understood that support mount 702 could have a curved surface (either convex or concave) and/or a textured surface (e.g., with a faceted or sawtooth pattern). Further, although FIG. 7 shows display device mount 706 as having a convex configuration, it is to be understood that display device mount 706 could be flat or concave. The surface of display device mount 706 could be textured in a pattern of two-dimensional facets, as described above. Alternatively, the surface of display device mount 706 could be faceted in one dimension, could be textured in other ways (e.g., with a sawtooth pattern), or could have a smooth surface.

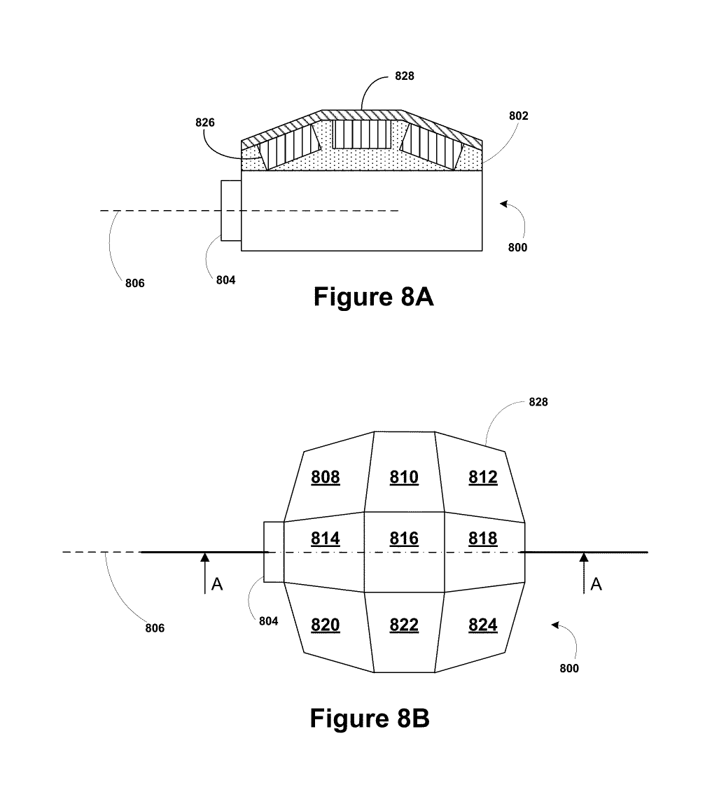

FIGS. 8A and 8B illustrate a display device 800 with a “tortoise shell” display device mount 802 that may be magnetically attached to a corresponding support mount, such as support mount 702. Display device 800 includes an aperture 804 through which displayed images are viewable along a viewing axis 806. As best shown in FIG. 8B, the “tortoise shell” configuration of display device mount 802 is defined by a two-dimensional array of facets 808-824. FIG. 8A is a side view of display device 800 in which display device mount 802 is shown partially cut away looking from left to right at section line ‘A’ in FIG. 8B. In this example, display device mount 802 includes a plurality of magnets 826 covered by a textured sheet 828 of ferrous material. Each one of magnets 826 is positioned under a corresponding one of facets 808-824 formed in textured sheet 828.

Facets 808-824 allow the pitch and roll of display device 800 to be adjusted in discrete increments. For example, if facet 816 is attached to support mount 702, the pitch of display device 800 may be adjusted by rotating display device 800 about a first axis so that facet 814 or facet 818 is attached to support mount 702. Alternatively, if facet 816 is attached to support mount 702, the roll of display device 800 may be adjusted by rotating display device 800 about a second axis so that facet 810 or 822 is attached to support mount 702. Finally, if facet 816 is attached to support mount 702, the yaw of display device 800 may be adjusted by rotating display device 800 about a third axis, so that facet 816 remains attached to support mount 702 but in a different orientation. Each of these adjustments results in a corresponding adjustment in the orientation of viewing axis 806. Furthermore, a series of adjustments in the pitch, roll, and/or yaw of display device 800 may be undertaken until viewing axis 806 has a desired orientation (e.g., extending from aperture 804 to wearer's eye 712).

Although display device mount 802 has nine facets in the example shown in FIG. 8B, it is understood that display device mount 802 may include a greater or fewer number of facets. In particular, a greater number of facets may allow for a greater number of discrete mounting orientations on support mount 702 and may allow for a finer adjustment in pitch and/or roll.

### CONCLUSION

The above detailed description describes various features and functions of the disclosed systems, devices, and methods with reference to the accompanying figures. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A head-mounted display, comprising:
a head-mounted support;
a display device, wherein the display device has an aperture through which an image is viewable along a viewing axis from a viewing point;
a support mount on the head-mounted support, wherein the support mount comprises an adjustment surface; and
a display mount on the display device, wherein the display mount is magnetically attached to the support mount such that the display mount is slidably adjustable on the adjustment surface through an adjustment range that moves the aperture of the display device, wherein the adjustment surface has a curved shape that corresponds to an arc centered at the viewing point.

2. The head-mounted display of claim 1, wherein the viewing point corresponds to an eye of a wearer of the head-mounted display.

3. The head-mounted display of claim 2, wherein the arc is in a vertical plane.

4. The head-mounted display of claim 3, wherein the adjustment surface comprises a curved metal surface.

5. The head-mounted display of claim 4, wherein the display mount is slidably adjustable on the curved metal surface in a vertical direction.

6. The head-mounted display of claim 5, wherein the curved metal surface has a curvature in the vertical direction

7. The head-mounted display of claim 6, wherein the support mount further comprises a slot and the curved metal surface is disposed in the slot.

8. The head-mounted display of claim 7, wherein the slot allows the display mount to slide along the curved metal surface in the vertical direction but restricts horizontal movement of the display mount.

9. The head-mounted display of claim 8, wherein the display mount comprises a mounting surface.

10. The head-mounted display of claim 9, wherein the mounting surface has a width that substantially corresponds to a horizontal width of the slot.

11. The head-mounted display of claim 9, wherein the mounting surface is a flat surface.

12. The head-mounted display of claim 9, wherein the mounting surface is a curved surface that substantially matches the curvature of the curved metal surface in the vertical direction.

13. The head-mounted display of claim 9, wherein the mounting surface comprises a plurality of facets that provide a plurality of discrete mounting orientations.

14. The head-mounted display of claim 13, wherein the plurality of discrete mounting orientations provide a first plurality of discrete rotational orientations of the display device about a first axis.

15. The head-mounted display of claim 14, wherein the plurality of discrete mounting orientations further provide a second plurality of discrete rotational orientations of the display device about a second axis.

16. The head-mounted display of claim 3, wherein the adjustment surface comprises a first curved metal surface and a second curved metal surface, and the display mount comprises a first mounting surface and a second mounting surface.

17. The head-mounted display of claim 16, wherein the first and second mounting surfaces are slidably adjustable in a vertical direction on the first and second curved metal surfaces.

18. The head-mounted display of claim 17, wherein the head-mounted support is in an eyeglass configuration that includes at least one lens.

19. The head-mounted display of claim 18, wherein the first and second curved metal surfaces are on opposite sides of the at least one lens.

20. The head-mounted display of claim 17, wherein the first and second mounting surfaces are slidably adjustable in a horizontal direction on the first and second curved metal surfaces.

21. (canceled)

22. (canceled)

23. A head-mounted display, comprising:
a head-mounted support;
a display device, wherein the display device has an aperture through which an image is viewable along a viewing axis from a viewing point;
a support mount on the head-mounted support, wherein the support mount comprises an adjustment surface, wherein the adjustment surface comprises a plurality of facets; and
a display mount on the display device, wherein the display mount is magnetically attachable to the adjustment surface in a plurality of discrete mounting positions defined by the plurality of facets, wherein each of the discrete mounting positions corresponds to a respective position of the aperture of the display device along an arc, wherein the arc is centered on the viewing point and the viewing axis extends between the aperture and the viewing point for each of the discrete mounting positions.

24. The head-mounted display of claim 23, wherein the viewing point corresponds to an eye of a wearer of the head-mounted display.

25. The head-mounted display of claim 24, wherein the arc is in a vertical plane.

26. (canceled)

27. The head-mounted display of claim 23, wherein the display mount comprises at least first and second flat mounting surfaces.

28. The head-mounted display of claim 27, wherein the display mount is slidably adjustable in a vertical direction from a first discrete mounting position to a second discrete mounting position, wherein the first flat mounting surface is magnetically attached to a first facet and the second flat mounting surface is magnetically attached to a second facet in the first discrete mounting position, and wherein the first flat mounting surface is magnetically attached to the second facet and the second flat mounting surface is magnetically attached to a third facet in the second discrete mounting position.

29. The head-mounted display of claim 27, wherein the first flat mounting surface corresponds to a first magnet in the display mount and the second flat mounting surface corresponds to a second magnet in the display mount.

30. (canceled)

31. (canceled)

32. A head-mounted display, comprising:
a head-mounted support;
a display device, wherein the display device has an aperture through which an image is viewable along a viewing axis;
a support mount on the head-mounted support, wherein the support mount comprises an adjustment surface; and
a display mount on the display device, wherein the display mount comprises a convex mounting surface that has a plurality of facets, wherein the display mount is magnetically attachable to the support mount in a plurality of discrete mounting orientations defined by the plurality of facets, wherein the facets are arranged in a two-dimensional pattern on the convex mounting surface, wherein the display mount is slidably and rotatably adjustable on the adjustment surface in each of the discrete mounting orientations, and wherein each of the discrete mounting orientations corresponds to a respective orientation of the viewing axis.

33. (canceled)

34. The head-mounted display of claim 32, wherein the two-dimensional pattern comprises a matrix arrangement of at least nine facets.

35. The head-mounted display of claim 32, wherein each of the facets corresponds to a respective magnet in the display mount.

36. (canceled)

37. The head-mounted display of claim 32, wherein the adjustment surface is a flat surface.

38. The head-mounted display of claim 32, wherein the adjustment surface is a convex surface.

39. The head-mounted display of claim 32, wherein the adjustment surface is a concave surface.

40. The head-mounted display of claim 32, wherein the plurality of discrete mounting orientations includes at least one mounting orientation in which the viewing axis can be directed toward a viewing point by adjustment of the display mount on the adjustment surface.

41. The head-mounted display of claim 40, wherein the viewing point corresponds to an eye of a wearer of the head-mounted display.

42. The head-mounted display of claim 41, wherein the head-mounted support comprises a hat brim.
